(19) United States
(12) Patent Application Publication
(10) Pub. No.: US 2011/0206225 A1
(43) Pub. Date: Aug. 25, 2011

(54) Hearing aid and handling tool

(75) Inventors: Kenneth R. Møller, Smorum (DK); Jan T. L. Larsen, Smorum (DK); Jens Rosenstand, Smorum (DK); Frank E. Rasmussen, Smorum (DK)

(73) Assignee: OTICON A/S

(21) Appl. No.: 12/929,465

(22) Filed: Jan. 26, 2011

(30) Foreign Application Priority Data
Jan. 29, 2010 (EP) 10152161.5

(51) Int. Cl. H04R 25/00

(52) U.S. Cl. 381/314; 381/329

(57) ABSTRACT

A hearing aid and handling tool is provided, where the hearing aid has all parts thereof inside the ear canal and comprise a casing part with a retention element extending radially between the casing part and the circumference of an ear canal of a user. A sound exit is provided at a first side of the retention element and mechanical connection parts are provided at an opposed side of the retention element. According to the invention complementary mechanical connection parts are provided at the handling tool.

### CROSS-REFERENCE TO RELATED APPLICATION

The present application derives from U.S. Provisional Application No. 61/229,376, filed Jan. 29, 2010, the priority of which is hereby claimed. The priority of European Patent Application 10152161.5 filed 29 Jan. 2010, is also claimed.

### AREA OF THE INVENTION

The invention regards the problem which arises when a hearing aid is provided wherein all parts thereof are provided inside the ear canal and no elements extends outside the ear canal. Especially if it is wished that the user shall be empowered to extract and insert such a hearing aid into and out of the ear canal.

### BACKGROUND OF THE INVENTION

From prior art document WO 2005/077011 a removal tool is known, which comprises a shaft adapted to be grasped in the hand and a plurality of hooks coupled to a first end of the shaft. The hooks are configured to detachably engage a loop structure of the hearing aid device. With this removal tool it is possible to safely remove the hearing aid from a position deep within the ear canal, but the tool does not facilitate insertion of the hearing aid, as detaching the hooks from the loop structure is not possible when the hearing aid is inside the ear canal.

Prior art document U.S. Pat. No. 5,003,608 shows a hearing aid with a pull out part, which is to be gripped by the fingers of a user. The pull out part is movable between a first position where it is inserted inside the hearing aid and a further position where it extends away from the outer surface of the hearing aid. The movement between the two positions may be accomplished by magnetic forces from a magnet associated with a hand held tool. This allows a pull out string to be in-conspicuous, however, it does not provide a good association between a tool part and the hearing aid, such that the user may carry the hearing aid in or fastened to the tool part.

A hearing aid and handling tool is desired, which allows both insertion, pull out and handling outside the ear canal of the hearing aid. A secure attachment between the tool and the hearing aid is thus required, however such that the hearing aid may be detached from the handling tool once it is correctly inserted into the ear canal of a user.

### SUMMARY OF THE INVENTION

Further objects of the invention are achieved by the embodiments defined in the dependent claims and in the detailed description of the invention.

As used herein, the singular forms “a,” “an,” and “the” are intended to include the plural forms as well (i.e., to have the meaning “at least one”), unless expressly stated otherwise. It will be further understood that the terms “includes,” “comprises,” “including,” and/or “comprising,” when used in this specification, specify the presence of stated features, integers, steps, operations, elements, and/or components, but do not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements maybe present, unless expressly stated otherwise. Furthermore, “connected” or “coupled” as used herein may include wirelessly connected or coupled. As used herein, the term “and/or” includes any and all combinations of one or more of the associated listed items. The steps of any method disclosed herein do not have to be performed in the exact order disclosed, unless expressly stated otherwise.

In an embodiment of the invention a hearing aid and handling tool is provided whereby the hearing aid has all parts thereof inside the ear canal and comprise a casing part with a retention element extending radially between the casing part and the circumference of an ear canal of a user, whereby a sound exit is provided at a first side of the retention element and connection parts are provided at an opposed side of the retention wherein complementary connection parts are provided at the handling tool.

The retention element and the sound exit defines a first end of the hearing aid which is to face the tympanic membrane of a user when the hearing aid is inserted into the ear canal of a user. The opposite end of the hearing aid is to face the surroundings and at this end connection parts are provided, such that a stable connection between the handling tool and the hearing aid may be established. This allows the hearing aid to be safely inserted and extracted from the ear canal, and at the same time the complementary connection at the handling tool and the hearing aid allows safe and secure handling of the hearing aid once the hearing aid is out of the ear. This is important as hearing aids of this kind by nature has to be very small, and handling such hearing aids with the fingers is difficult or possibly impossible for elderly users with poor dexterity.

The hearing aid itself will comprise the usual parts which constitutes a hearing aid: a microphone for sensing sounds from the surroundings and transforming the sounds into electrical signals, a signal processing means which may enhance the sound content of the microphone signal according to the users liking and need, an output device adapted to deliver a signal to the user which is perceivable as sound. Also, the hearing aid will comprise a battery for delivery of electrical power to the transducers and circuitry. The output device is a speaker (usually called a receiver) which delivers a sound signal to the users ear drum. In order to isolate the microphone from the sounds produced from the receiver, the retention element may comprise a sealing property and is provided between the hearing aid casing part and the internal wall of the ear canal.

In an embodiment of the invention the hearing aid and the handling tool gains electrical contact over two separate contact points when the mechanical connection points interact for handling of the hearing aid. In this way charging of a rechargeable battery in the hearing aid may be accomplished via the handling tool. The tool may comprise a battery or a set of further connection points. The further connection point come into play when the tool with the hearing aid attached thereto is inserted into a charging device such that power may be supplied from the charging device via the further electrical connection of the handling tool and to the hearing aid.

The complementary connection parts of the handling tool or the hearing aid may comprise an actuator adapted to generate a magnetic field extending outside a connection part such that the actuator is switchable between a field generating state and a state where no field is generated. Such switchable magnetic field greatly facilitates insertion of the hearing aid into the ear, as the magnetic field extending outside the tool part may be used to secure the hearing aid to the tool, and by switching off this magnetic field the hearing aid may be released from the tool once inserted into the ear canal.

In an embodiment the magnetic actuator comprise either a ferromagnetic part or a permanent magnetic part arranged to move in either translational or rotational fashion to produce the magnetic field outside a surface part of the connection parts of the handling tool. Movable magnetic or ferromagnetic parts are very simple mechanical devices which may readily be provided in the tool part to control the magnetic field outside of the tool part.

In an embodiment the produced magnetic field is provided by an electromagnetic device. This is a very simple element to provide in the tool part, and the control thereof comprises a simple switch. Such a switch may readily be provided at the tool part, such that the user may easily control the position thereof, even if the tool is held at an awkward position, partially inserted into the ear canal.

In an embodiment the tool comprise a cylinder adapted for insertion into the ear canal and a magnetic plunger arranged slidable inside the cylinder and a shaft connected to the plunger such that the position of the plunger in the cylinder is controllable by manual operation of the shaft. The shaft may extend sideways out of the cylinder or it may extend out of an end part of the cylinder. In both instances, the plunger is movable in a direction towards and away from an end part of the tool, by way of the shaft, whereby the magnetic field outside the tool part is controllable.

In a further embodiment the tool comprises a first permanent magnet with a first polarization and a second permanent magnet, arranged proximal to the first magnet, whereby the second magnet is mounted in order to slide or rotate with respect to the first magnet, such that the two magnets in a first position of the movable magnet have magnetic fields mutually enforcing each other and in a second position have magnetic fields which cancel each other. This embodiment is advantageous in that a very strong magnetic field reaching out of the tool part may be switched on or of respectively.

In a further embodiment the interaction of the connection parts of the handling tool and the connection parts of the hearing aid is caused by relative rotation of at least a part of the handling tool with respect to the hearing aid. When the hearing aid is to be taken out of the ear, it is especially important that a reliable connection between the hearing aid and the handling tool is established and a mechanical connection based on a screwing motion of one part with respect to the other part such as a threaded connection will provide a safe and secure connection.

Preferably matching threads are provided on a hearing aid part and a tool part respectively. By this provision, the hearing aid and the tool part are easily secured to one another both when the hearing aid is to be extracted and also at insertion. A screwing motion of tool tip part can be accomplished easily with a simple shaft, which may be rotated by the users fingers. This shaft may be provided in a bearing in the tool such that the tool itself is not rotated but only the shaft part. If desired a linear motion of a tool part may be translated to a rotational motion of the shaft in a usual way by a usual thread and cam arrangement.

In another embodiment a bayonet joint is provided between the hearing aid and the handling tool. Such a bayonet joint has the advantage that only a very limited rotational motion between the hearing aid and tool part is required, to ensure a secure attachment of the hearing aid to the tool.

In a further embodiment the tool tip is shaped with a corkscrew like element and connection parts of the hearing aid comprise loops of wires extending from a surface part thereof. This connection is very simple to produce, and the hearing aid and tool part may readily be separated when the hearing aid is inserted into the ear by simply on-screwing the cork-screw from the wires looping at the end of the hearing aid.

In a further embodiment spring loaded locking elements are provided at the handling tool or the hearing aid connection part and mounted for radial movement into and out of engagement with corresponding recesses at the respective opposed part. The radial movement of these spring loaded elements into engagement with recess of an opposed part will facilitate a secure and stable connection between the hearing aid and the handling tool.

In a further embodiment the spring loaded elements are provided at the handling tool and comprise ball shaped elements which are movable radially inwardly against the spring load by manual operation of a handle placed at the tool. By this provision the movement of the ball shaped element is readily controlled at the tool part by the user, and thereby no axial pressure is necessary in order to ensure a safe grip between the tool and the hearing aid. This is important as the tympanic membrane of the user is very sensitive and it shall be avoided at all times that axial pressure is exerted on the hearing aid, which might lead to contact between the hearing aid and the tympanic membrane.

In a further embodiment the hearing aid comprise a spring loaded element which is displaceable radially inwardly against the spring load by the tool in order to lock into radially disposed recesses at the tool part. The spring loaded element preferably comprise a ball or balls which are pressed radially outward by a spring, such that the tool part may press the balls radially slightly inward, where after the balls by way of the spring load may move radially outward to become seated in recesses provided in the tool.

In a further embodiment the handling tool comprise tongs or nippers which, against a spring load, are actuable to grip a protruding part of the hearing aid.

In a preferred embodiment a guiding magnet is provided at either the tool part or the hearing aid connection part to facilitate correct positioning of the tool part with respect to the hearing aid connection part. Such a guiding magnet may aid the user in a big way to have the tool correctly placed relative to the hearing aid inside the ear, as the tool cannot be observed during insertion and extraction of the hearing aid.

In yet an embodiment a flexible link is provided between the connection means and the hearing aid or the tool part respectively. Such a link will aid in providing a reliable connection between the hearing aid and the handling tool when the ear canal of the wearer is not straight but has a marked bend. With a flexible link the tool tip may be manoeuvred inside the ear canal to the right position relative to the hearing aid.

In an embodiment the handling tool comprise a handle part and a first connection part extending from the handle part and a second connection part opposed to the first connection part. Having two connection parts extending from one and the same handle part allows the user to use the one and same tool for extracting a hearing aid from each of his ears.

In an embodiment the tool part comprise an extending element shaped to enter into the ear canal of a hearing aid wearer and stop element proximal to the extending element and shaped to prevent extension thereof into the ear canal. This security measure aids to prevent pain or damage to the ear canal and the tympanic membrane when the user attempts to extract a hearing aid.

Preferably the length of the extending element is adjustable, such that it may be customized to the individual user.

### BRIEF DESCRIPTION OF THE DRAWINGS

FIG. 1 shows a hearing aid according to the invention,

FIG. 2 a hearing aid and handling tool partly inside the ear canal of a user,

FIG. 3 a hearing aid being extracted/inserted from the ear canal of a user,

FIG. 4 a charger for the hearing aid or the handling tool according to the invention,

FIG. 4A is side view of a hearing aid according to the invention shown form two sides

FIG. 4B is a partial sectional view of a handling tool,

FIG. 4C is a hearing aid, a handling tool, and a charging unit according to the invention

FIG. 5 shows an electromagnetic device with a control element,

FIG. 6 is a handling tool in a side view,

FIG. 6A shows a handling tool shown in side view and a sectional view,

FIG. 6B is a further embodiment of a handling tool shown in a sectional view,

FIG. 6C is a further embodiment of the hearing aid and handling tool shown in FIG. 6A,

FIG. 7 is a sectional view of a further embodiment of a handling tool,

FIG. 7A is a sectional view of the handling tool in FIG. 7,

FIG. 7B is a sectional view of a further embodiment of the handling tool,

FIG. 8 is a side and top view of a further handling tool,

FIG. 8A is a side view of a further example of a handling tool,

FIG. 9 shows various examples of hearing aids according to the invention,

FIGS. 10 and 10A shows different example of hearing aids according to the invention,

FIGS. 11 and 11A and 11B shows further examples of hearing aids according to the invention,

FIG. 12 shows a further example of a hearing aid and handling tool according to the invention,

FIG. 12A shows a handling tool and hearing aid in sectional view, where left and right hand side of the figure depicts the tool in two different positions,

FIG. 12B shows a further example of a hearing aid and handling tool in sectional view,

FIG. 12C shows a handling tool and hearing aid in sectional view 3 times with the tool in each its position,

FIG. 13 shows a further example of a hearing aid and handling tool according to the invention,

FIG. 14 shows a further example of a hearing aid and handling tool according to the invention,

FIG. 14A shows sectional views of a tool in 2 different positions,

FIGS. 14B and 14C show likewise sectional views of two different embodiments of a tool,

FIG. 15 shows a further example of a hearing aid and handling tool according to the invention,

FIG. 15A shows a perspective view of an embodiment of the tool,

FIG. 15B shows a sectional view of the tool shown in FIG. 15A,

FIGS. 16 and 16A show further examples of a handling tool,

FIG. 17 shows a further example of a hearing aid and handling tool according to the invention,

FIGS. 18, 18A and 18B show a further example of a hearing aid and handling tool according to the invention,

FIGS. 19, 19A show a further example of a hearing aid and handling tool according to the invention,

FIG. 20 shows a further example of a hearing aid and handling tool according to the invention.

The figures are schematic and simplified for clarity, and they just show details which are essential to the understanding of the invention, while other details are left out. Throughout, the same reference numerals are used for identical or corresponding parts.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### DESCRIPTION OF A PREFERRED EMBODIMENT

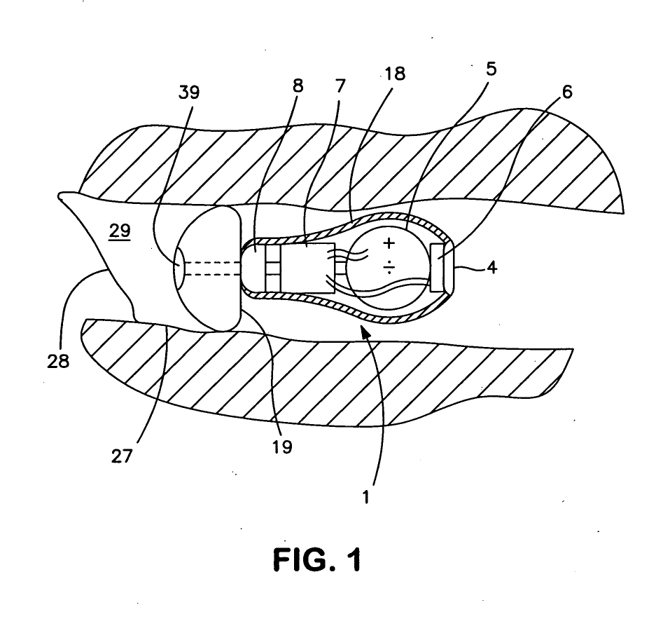

A hearing aid 1 is shown in FIG. 1 alone and without the handling tool. The hearing aid is shaped with an outer casing 18 which is sized to enter deep into the ear canal 29 of most hearing aid users. Internally of the casing 18 the various components of the hearing aid 1 are provided: a battery 5 for power delivery, a microphone 6 which transforms surrounding sounds into an electrical signal, a signal processing device 7 which processes the electrical signal from the microphone and provides a processed electrical signal which is served at a receiver 8. The receiver 8 has a sound producing opening or sound exit 39 which will produce sound in the vicinity of the tympanic membrane 28, when the hearing aid is placed inside the ear canal 29 of a user. A dome 19 or sealing element is provided for sealing the space between the hearing aid casing 18 and the internal wall 27 of the ear canal 29 of a user. The dome 19 may be an open dome and mainly function as retention element. As seen in FIG. 1 the hearing aid has all parts thereof inside the ear canal. Mechanical connection parts 4 are provided at an opposed side of the sealing element 19. And as explained in the following complementary mechanical connection parts are provided at the handling tool, such that the user may extract the hearing aid from the ear and also insert it to the correct position with the sound exit 39 close to the tympanic membrane 28.

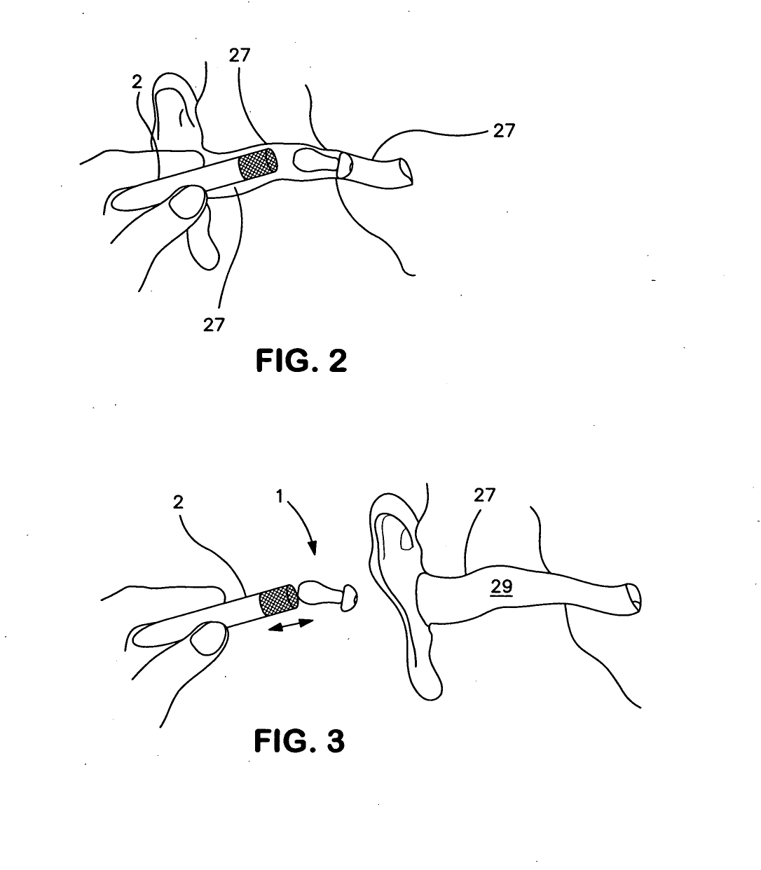

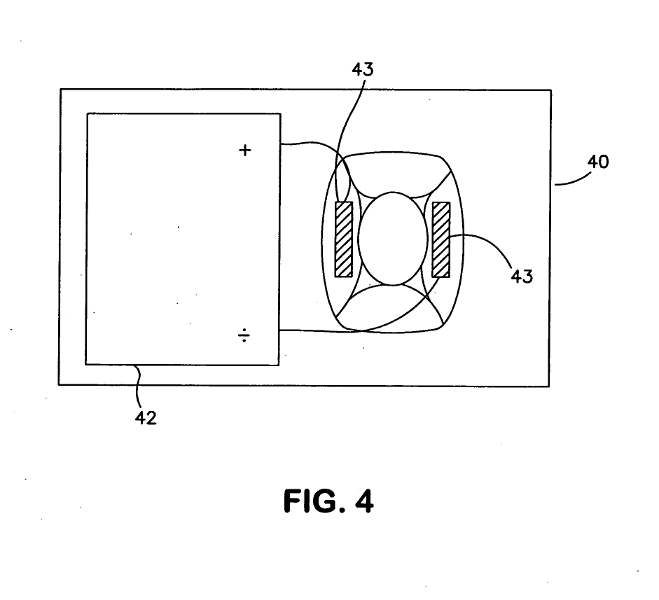

In FIGS. 2 and 3 a general outline of the hearing aid and tool is shown. The handling tool 2 is to be held by the fingers of the user, and the hearing aid shall be releasable adhered to a tip portion of the tool as shown in FIG. 2. As seen in FIG. 2 the tool tip is adapted to be inserted into the ear canal 29. When the hearing aid is to be inserted it is initially fastened to the tool tip as shown in FIG. 3 and the hearing aid and tool are inserted to the position as shown in FIG. 2, and here the hearing aid is released from the tip of the tool, and the tool 2 is taken out of the ear. When the tool is used for extraction, it is inserted into the ear canal to a position adjacent to or abutting the hearing aid 1, and the hearing aid becomes attached or adhered to the tool tip, such that the hearing aid may be extracted from the ear canal 29 along with the tool 2. During daily use it must be ensured, that the tool is never inserted too deep into the ear canal, which might cause injury or pain, and it must be ensured that the user is capable of safe removal and safe insertion of the hearing aid. Thus, a reliable release and adherence mechanism is to be ensured by the invention.

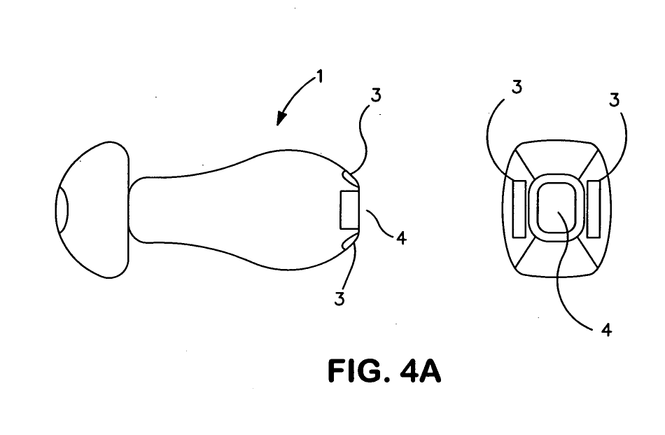

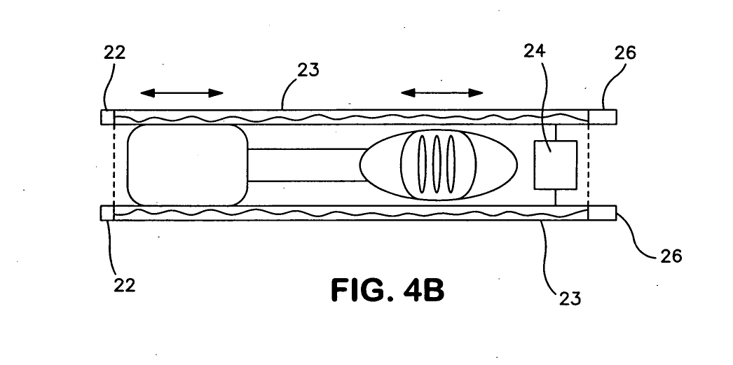

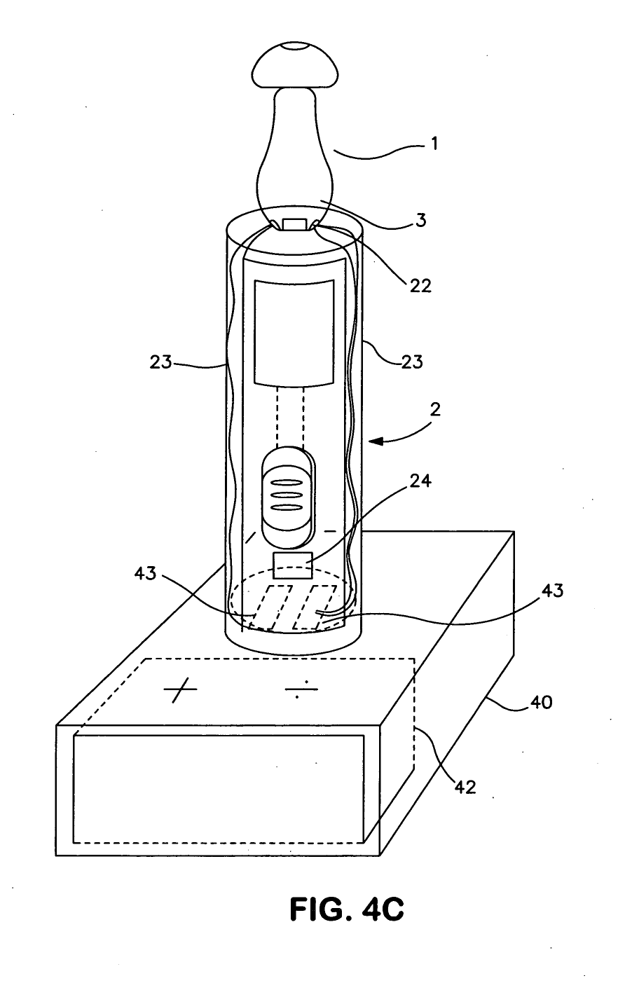

In FIG. 4 a charger 40 is shown wherein the hearing aid 1 may be seated for recharging of a rechargeable battery in the hearing aid 1. The charger 40 comprises a power source 42 for establishing charging power at charging points 43. The power source 42 may comprise a larger battery or it may be in the form of a transformer being connected to a power line as is well known in connection with re-chargeable batteries.

In FIG. 4A the corresponding hearing aid 1 is shown, with charging contacts 3, and a ferromagnetic or permanent magnetic plate 4. The hearing aid in FIG. 4A may be seated in the charger 40.

In FIG. 4B the handling tool is shown having electric connection points 22 which are arranged to contact the connection points 3 of the hearing aid 1 when the hearing aid is seated in the tool. Leads 23 are provided inside the tool to provide contact between the contact points 22 and further contact points 26 at the rear end of the tool.

In FIG. 4C a hearing aid is shown seated in a handling tool 2. Two separate electrical connections 3 are provided at the hearing aid; and at the handling tool corresponding connections 22 are provided which are in contact with each other whenever the hearing aid 1 is seated in the handling tool. Further, in FIG. 4C the charger 40 is shown, and as seen the connection tool 2 is seated therein and electrical connections 26 at the one end of the handling tool contacts the charging points 43 thereof, and through the leads 23 in the handling tool 2, the charging points 43 of the charger gains contact with the rechargeable battery in the hearing aid 1. This aids the hearing aid user, who does not have to handle the very small hearing aid alone, as he can do with handling the assembly of hearing aid and handling tool, also when the hearing aid is to be seated for recharging. The handling tool 2 may comprise a rechargeable battery 24 of its own, such that the hearing aid may be charged therefrom. Thus, for a shorter duration of time, the hearing aid user may travel without the charging box, as long as the handling tool 2 is within reach. Charging the hearing aid through the tool may be accomplished with any of the tools disclosed in this application.

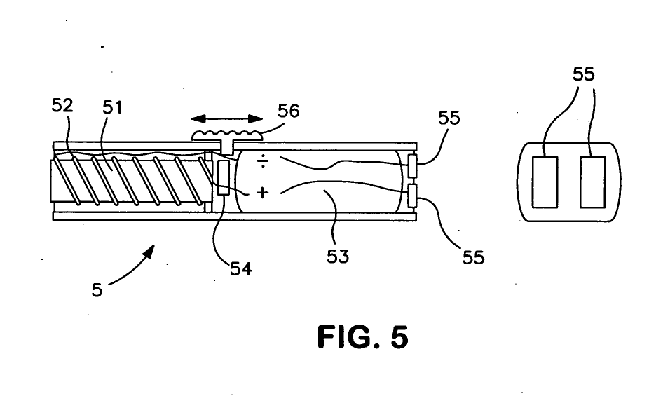

In FIG. 5 an electromagnetic device 50 is shown which may form part of the tool. The electromagnetic device is essentially an iron core 51 with an electric lead 52 wound around the core 51. The winding may be powered by a battery 53 and the device is controlled by a switch 54, which controls the electromagnetic device. An external button 56 may be provided for the control of the switch 54. The battery 53 may be a re-chargeable battery and charging poles 55 will in this case have to be provided for recharging the battery. The electromagnet shown in FIG. 5 may be employed in the tool at any point in this description where a magnetic or ferromagnetic device is mentioned.

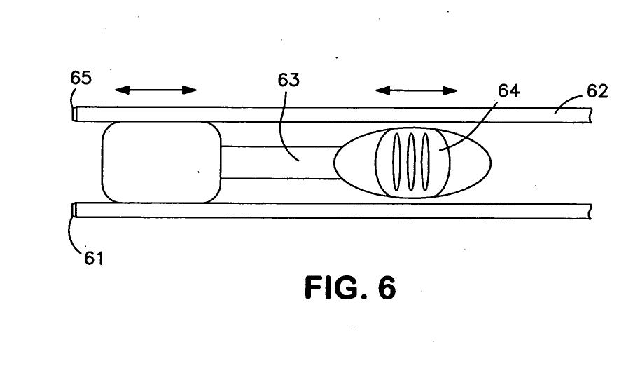

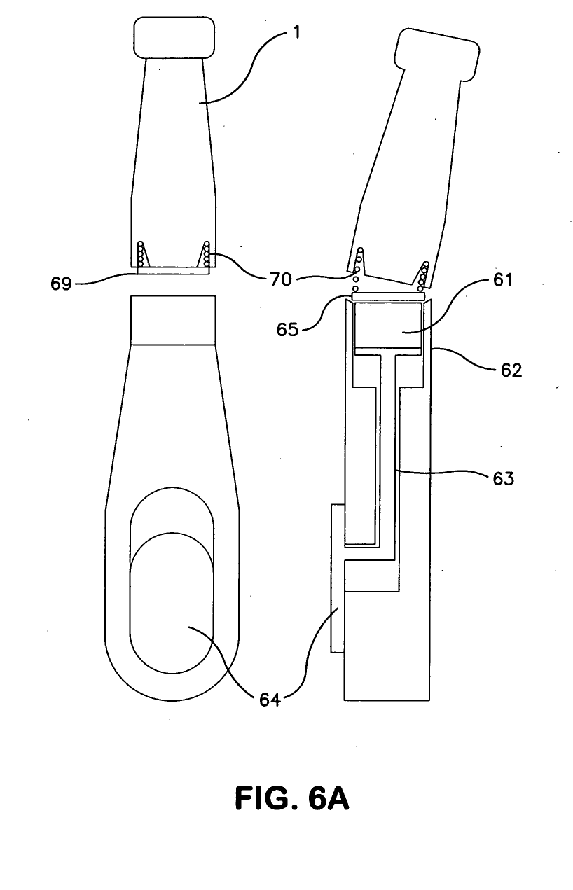

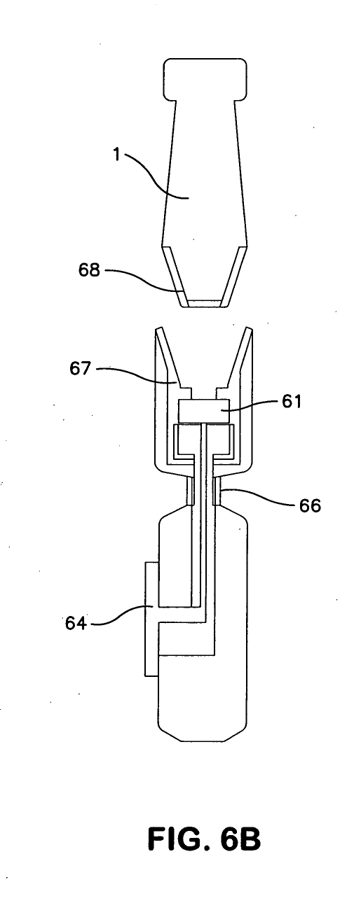

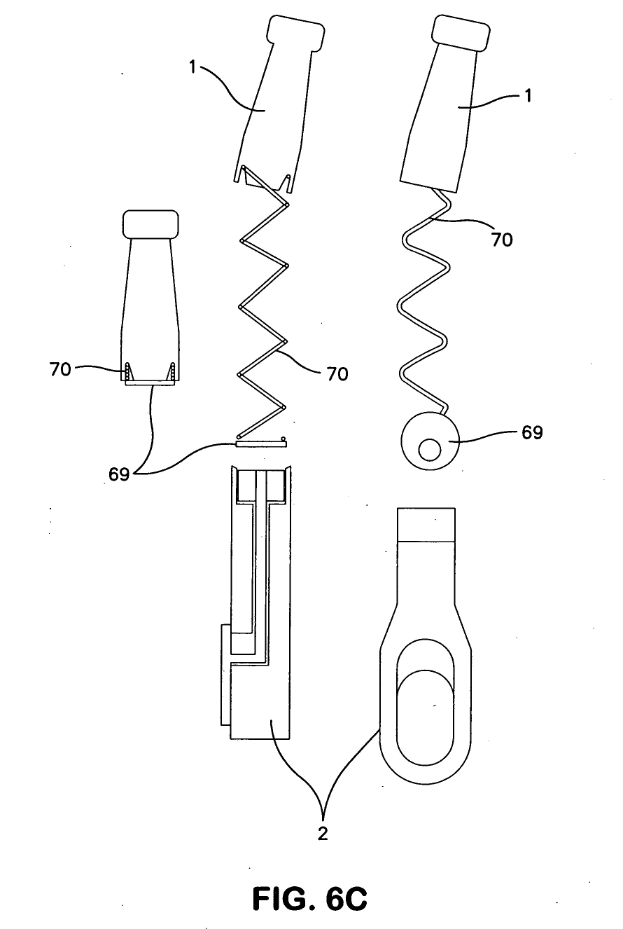

In FIG. 6 a tool is disclosed which comprise a cylinder 62, adapted for insertion into the ear canal, and a magnetic plunger 61 arranged to slide inside the cylinder 62. A shaft 63 is connected to the plunger 61 such that the position of the plunger 61 in the cylinder 62 is controllable by manual operation of the shaft 63. This is possible in a simple manner by a knob 64 connected to the shaft. When the hearing aid is to be extracted from the ear canal, the plunger 61 is placed in the foremost position in the cylinder as shown in FIG. 6 and the tool is inserted into the ear and as a result of the position of the magnet a good grip on the hearing aid connection part (which in this case will comprise a ferromagnetic element) will be obtained, such that by pulling the tool out of the ear, the hearing aid will follow magnetically coupled to the tool. When the hearing aid is to be inserted the hearing aid is placed at the tool and inserted with the tool into the ear canal, and following insertion the plunger is pulled back by pulling at the knob 64, whereby the magnet 61 is pulled away from the hearing aid. The edge parts 65 of the tool will ensure that the hearing aid stays inside the ear canal when the magnetic plunger 61 is pulled back.

In FIG. 6A a tool and hearing aid is shown which is much like the above described with reference to FIG. 6. The hearing aid 1 and tool in FIG. 6A is shown in a plane view in the left hand side in FIG. 6A has the iron or magnet plate 69 to which the magnetic plunger 61 attaches, connected to the hearing aid by means of one or more flexible elements 70 such as chains or springs. In this way, the tool may gain a grip on the hearing aid iron part 69 even if the two are not completely aligned when the tool is inserted into the ear. The edge parts 65 of the walls 62 of the tool are arranged such that the iron plate 69 will not be drawn into the tool, when the plunger 63 is drawn back by means of handle 64 when the hearing aid is to be released inside the ear of a user.

In FIG. 6B a similar tool and hearing aid pair is shown, however, in this case the tool has a neck part 66 which is flexible such that the part lying above the neck 66 may be angled and better reach the hearing aid 1. The handle 64 is provided in the same way as in the FIG. 6A embodiment, but the magnetic plunger 61 is provided to abbot a ferromagnetic insert 67, which will become magnc when the plunger is pushed towards it, and thus attract the magnetic or ferromagnetic part 68 of the hearing aid rear end.

The FIG. 6C embodiment is a little different from the FIG. 6A embodiment in that the spring or chain 70 is made excessively long such that it may be pulled away from the hearing aid and extend outside the ear canal in order to be gripped by the fingers of the user. The pulling away from the hearing aid is accomplished by the magnet catching on the metal plate 69 when the hearing aid is in the ear, and then pulling the tool 2 out of the ear. At the left hand side of the drawing the spring element 70 is shown in two different versions also which each their plate like element 69 at the end thereof. When the spring 70 is folded onto the hearing aid it will be embedded in a backend part thereof as seen in the right hand side of the drawing, where the hearing aid 1 is shown with the spring 70 pressed together inside the hearing aid 1. The advantage with this embodiment is that the magnetic attraction between the tool and the hearing aid part need not be overly strong. It suffice to have a magnetic force strong enough to detach the magnetic or magnetizable plate 69 from the hearing aid.

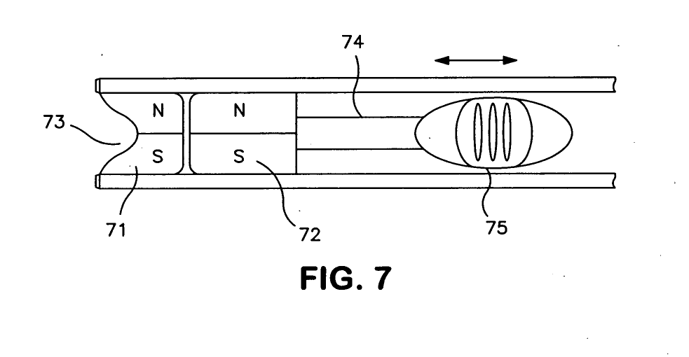

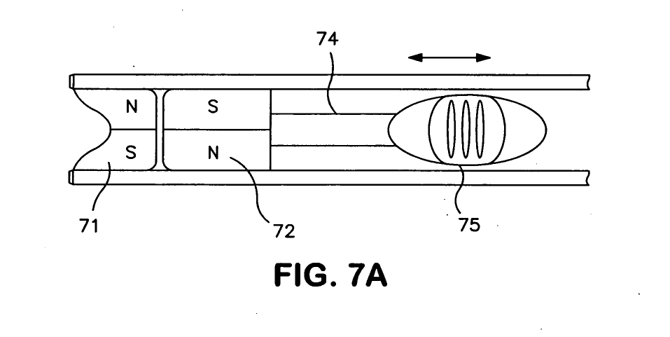

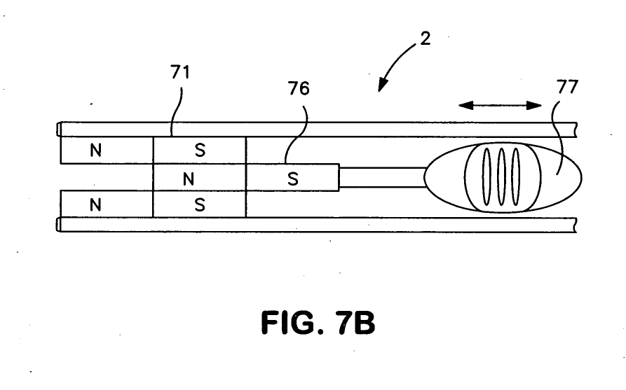

In FIGS. 7 and 7A the tool comprises a first permanent magnet 71 with a first polarization indicated by letters “S” and N″ and a second permanent magnet 72, arranged proximal to the first magnet. The second magnet 72 is mounted in order to rotate with respect to the first magnet 71, such that the two magnets in a first position of the movable magnet have magnetic fields mutually enforcing each other as shown in FIG. 7. In this position the magnetic field outside the tool end at 73 will be stronger and this is used for extraction or insertion of the hearing aid. And, as shown in FIG. 7A, the second magnet 72 is placed in a second position in order that the two magnets have magnetic fields which cancel each other. Whereby the magnetic force outside the tool end will be weak and this is used when the hearing aid is to be released from the tool 2, such as when the tool is to be extracted after insertion of a hearing aid. The second magnet 72 is turned by means of a simple screw 74 which is rotated by way of a simple cam impeller (not shown) which is manoeuvred by a slidable button 75. The magnets 71,72 are rotated with respect to each other in the above example of the invention, but a similar effect may be realized with two or more magnets arranged slidable with respect to each other. This is shown in more detail in FIG. 7B. The annular magnet 71 in FIG. 7B is arranged permanently at the end of the tool, and the magnet 76 is arranged slidable within the tube shaped by the annular magnet 71. The magnet 76 is moved by slider 77 from a position wherein the two magnets 71 and 76 co-operate in generating a magnetic field outside of the tool 2 and to a position where the two magnets are arrange to cancel their respective magnetic fields each other.

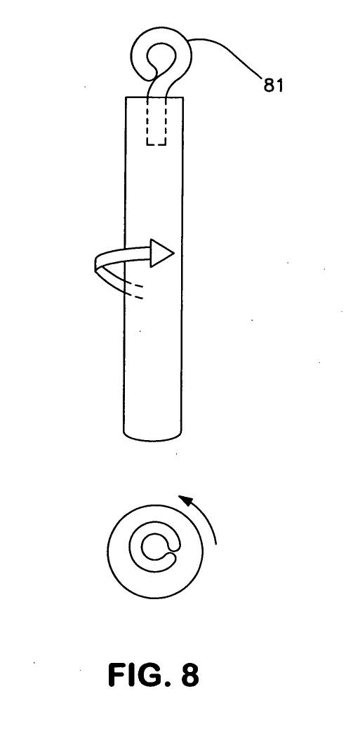

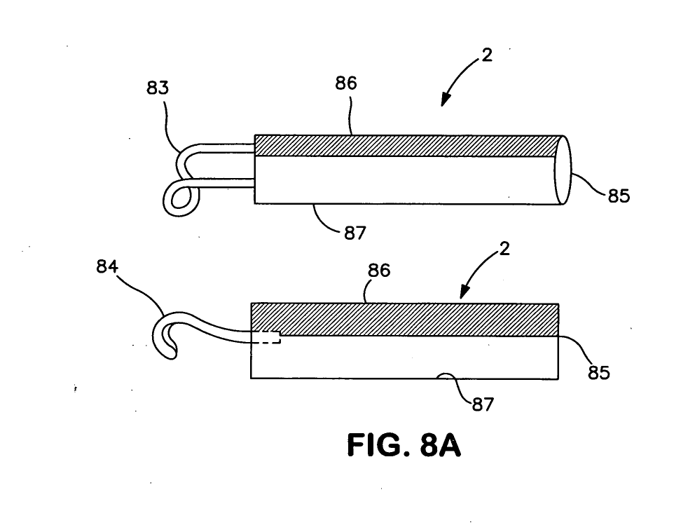

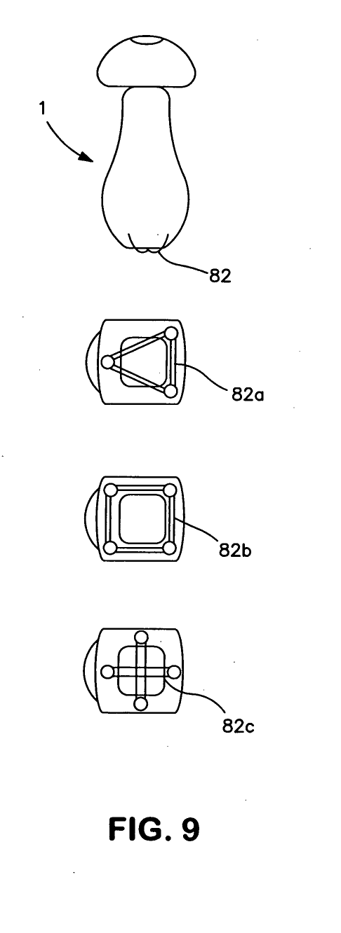

In FIG. 8 the tool tip is shown shaped with a corkscrew like element 81. The connection parts of the hearing aid are also shown and they comprise loops of wires 82, 82A, 82B, 82C (seen in FIG. 9) extending from a surface part thereof. The corkscrew like element 81 is inserted into the ear canal to a position adjacent to the wires and then the tool 2 or tool tip is rotated whereby one or more of the loops of wire 82, 82A, 82B, 82C will become entangled with the corkscrew like extension 81 of the tool 2. Hereafter the tool is extracted with the hearing aid adhered thereto. Similarly, when the hearing aid is inserted the tool with the hearing aid is inserted into the ear canal and following this the tool is rotated, (now in the opposite direction) and the loops of wires will become dis-entangled from corkscrew extension 81.

In FIG. 8A two further embodiments of the tip portion of the tool 2 are shown, which are usable in connection with wire loop extending from the hearing aid. A hook like element 83 could be used, and by providing the hook like element as a loop of resilient wire it is ensured that the inside of the ear canal is not injured by this element. A simple wire hook 84 is also usable, but possibly it shall be ensured that the hook is made from relative soft material to avoid injury of the ear canal. The handle part 85 of the two handling tools shown in FIG. 8A have a first part 86, and a second part 87 with each their colour marking, and the parting line between the two colour markings is arranged along a horizontal line in the situation where the user is to extract/insert a hearing aid. In case the tool needs a special orientation in order to ensure a correct interaction with the hearing aid this colour marking 86 will aid the user in handling the tool correct. This feature, even if not shown, may be employed at the other embodiments disclosed in the application to facilitate correct orientation/rotation of the tool with respect to the ear.

FIG. 9 discloses various different ways of arranging the loops of wires at the hearing aid. Crossing wires are shown at 82C, wires forming a square are shown at 82B and wires forming a triangle are shown at 82A. These may be used in various combinations or alone to ensure a safe grip between a tool and the wires.

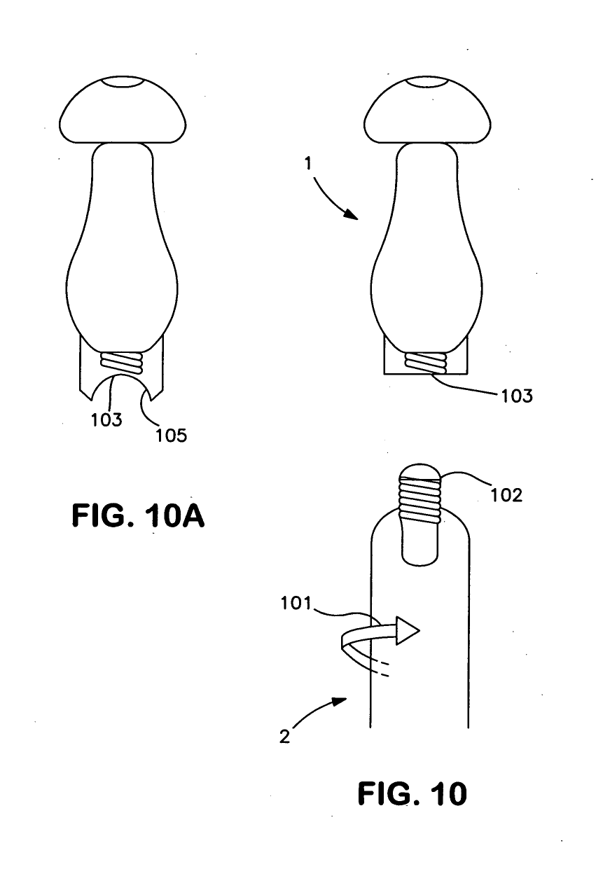

In the embodiment shown in FIG. 10 the interaction of the connection parts of the handling tool 2 and the connection parts of the hearing aid 1 is caused by relative rotation of the handling tool 2 with respect to the hearing aid 1. As indicated in the figure by arrow 101 the tool 2 is rotated, whereby external threads 102 at a tip part of the tool 2 are to interact with internal threads 103 provided on a rear part of the hearing aid 1 when the tool is moved into contact with the hearing aid and rotated at the same time. In this way a secure connection between tool 2 and hearing aid 1 can be ensured with very simple and well known means.

In FIG. 10A an embodiment is shown wherein further the threads 103 on the hearing aid are surrounded by a funnel shaped element 105, which will aid in guiding the tip of the tool part into abutment with the threads.

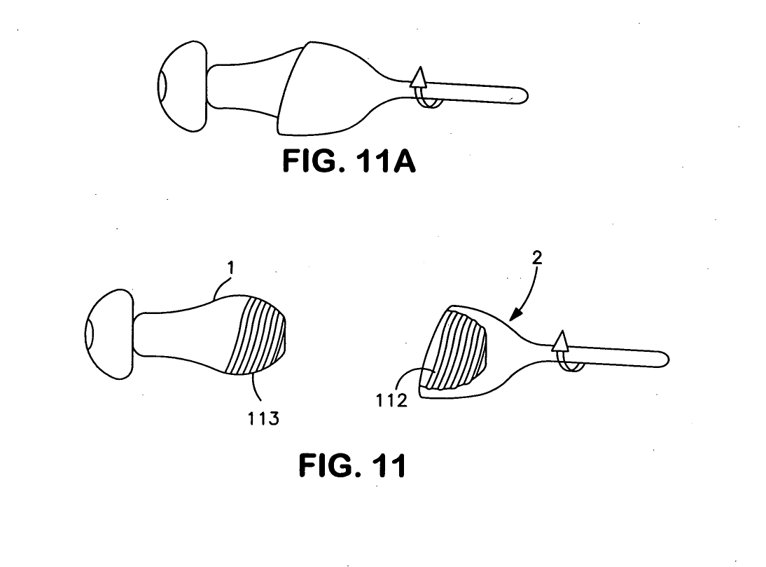

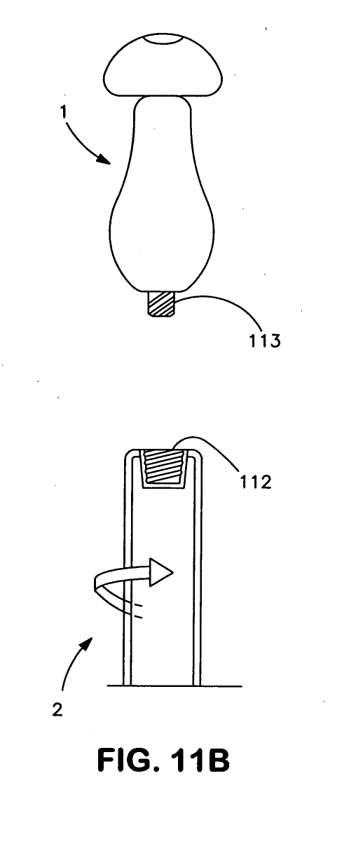

In FIGS. 11 and 11A a further example of the above principle is shown, however her the internal threads 112 are provided at the tool part 2, and the external threads 113 are associated with the hearing aid 1. In FIG. 11A the handling tool and the hearing aid are shown in an assembled state. A further example of this is shown in FIG. 11B with the difference that the treads on the hearing aid 1 in FIG. 11B are provided at a thread stub and not as shown in FIG. 11A at the exterior surface of the hearing aid body as such.

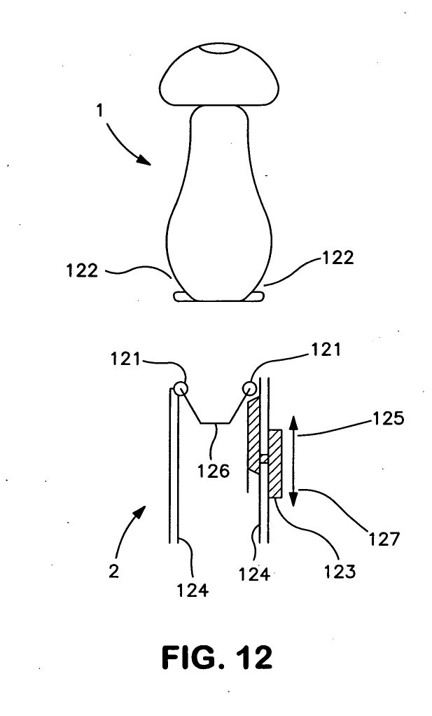

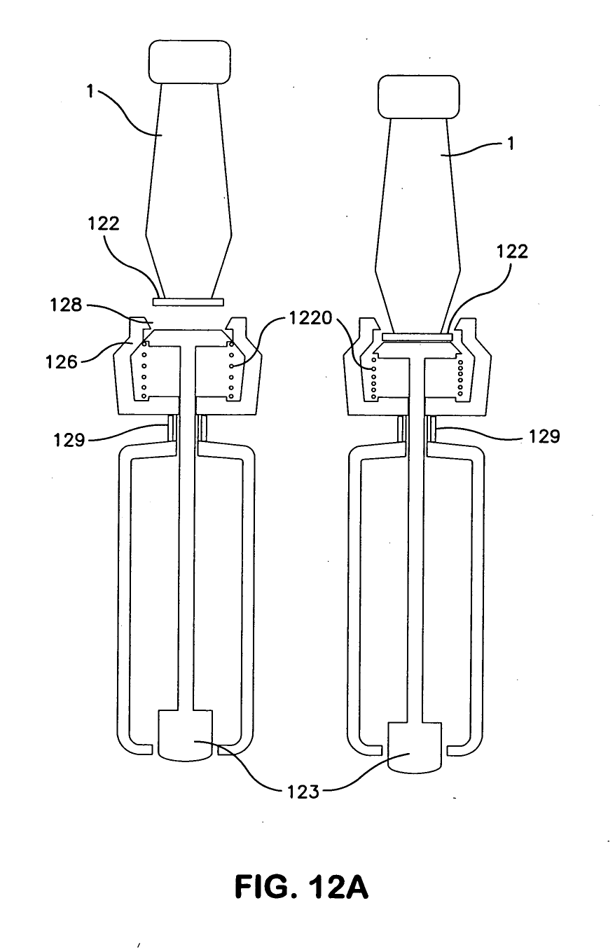

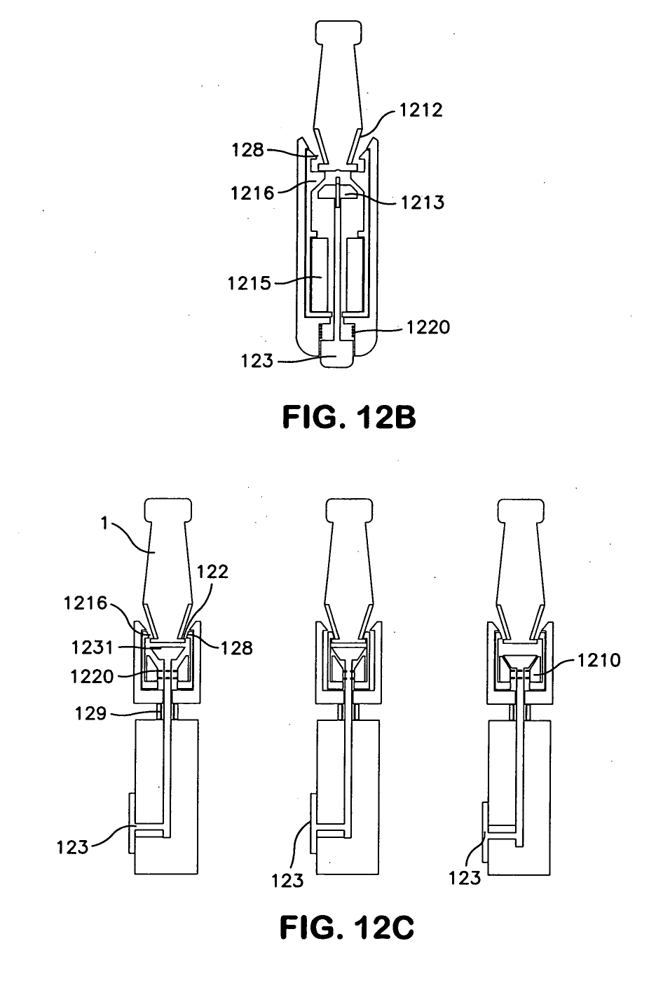

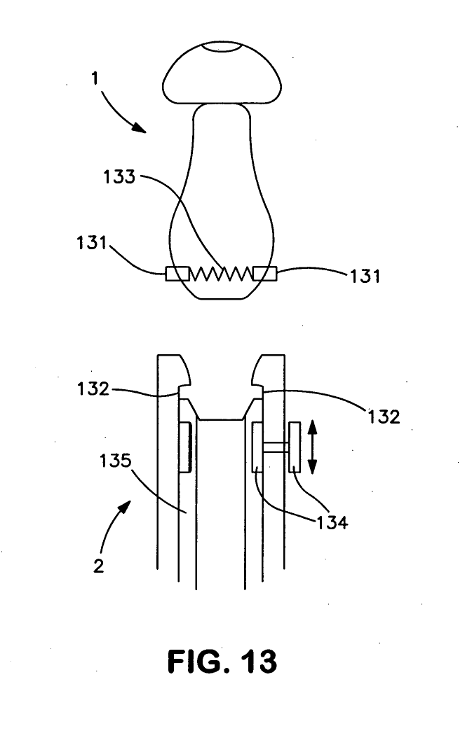

In the embodiment shown in FIG. 12, spring loaded locking elements 121 are provided at the handling tool 2. As shown in the following, the spring loaded elements could likewise be provided at the hearing aid. The spring loaded elements 121 are mounted for radial movement into and out of engagement with corresponding recesses 122 at the respective opposed part, which in FIG. 12 is the rear part of the hearing aid 1. As seen in the figure the spring loaded elements 121 comprise ball shaped elements which are movable radially inwardly against the spring load by manual operation of a handle 123 placed at the tool 2. The handle 123 is in operative engagement with a cylindrical slider 124, such that a forward movement of the handle in the direction of the arrow 125 will press the ball shaped elements 121 radially inwards. If the tool is initially placed in abutment with the hearing aid 1 and the handle 123 followingly is moved in the direction of arrow 125 a locking engagement between the tool 2 and the hearing aid 1 will ensure. Due to the spring 126 the hearing aid is releasable from the tool 2 simply by movement of the handle 123 in the direction of the arrow 127, whereby the ball shaped elements 121 will move radially outwards and out of the recesses 122 where after the tool may be retracted away from the hearing aid. This is done when the hearing aid is to be placed inside the ear canal.

In FIG. 12A a further embodiment of the invention shown in FIG. 12 is schematically shown. The tool couples to the hearing aid by way of a movable hook like structure 128, which is manoeuvred by way of a knob or handle 123. In the left hand side of the figure, the hearing aid 1 is detached from the tool, and the handle 123 is pressed upwards, such that the hooks 128 at side elements 126 are spread apart. In the right hand side the hearing aid 1 is seated in the tool, the hooks 128 have gripped into recess 122 on the hearing aid 1, and the handle 123 is pressed down and protrudes from the general surface of the tool. A flexible neck portion 129 is provided such that the gripping hooks 128 may gain a secure grip in the recess 122 even if the tool and hearing aid centre axis are not aligned.

A further embodiment of the above principle is disclosed in FIG. 12B. Here a strong magnet 1215 is provided, which magnetise magnetisable elements 1216 such that the inward movement of hooks 128 will take place whenever the hearing aid rear end with magnetisable elements 1212 are within range. In order to release the hearing aid in the ear, the plunger 1213 is provided in much the same manner as disclosed in FIG. 12A, such that movement thereof by way of handle 123 will force the hooks 128 outwards and away from the recesses 122. The handle 123 is connected to plunger 1213 through a simple shaft, and the plunger 1213 has chamfered surfaces abutting similarly chamfered internal wall parts of magnetisable parts 1216 whereby the translational movement of the plunger 1213 will cause the hooks 128 move in radial direction to gain or release the grip at recess 122 as explained.

In FIGS. 12A, 12B and 12C a spring element 1220 ensures the return stroke of the handle 123.

The embodiment shown in FIG. 12C the magnets 1210 are placed above a neck part 129 and are mounted to move in unison with the ferromagnetic elements 1216 in order to provide the grip between the hooks 128 and recesses 122. The neck part 129 is flexible and allows the top part of the tool to be angled with respect to the handle part in order to ensure capture of a hearing aid inside the ear. In the left hand side drawing part of FIG. 12C the plunger 1231 has been pushed forward to release the magnets 1210, and in the middle part the magnets 1210 have been drawn together pulling the hooks 128 into recesses 122 to provide a firm grip between the hearing aid 1 and the tool. In the right hand side of the drawing the handle 123 has been pulled back and the plunger 1231 has pushed the magnets 1210 apart to cause release of the hearing aid from the tool.

In FIG. 13 the hearing aid 1 comprise, spring loaded elements 131 which are displaceable radially inwardly against the spring load by the tool 2 in order to lock into radially disposed recesses 132 at the tool part. The spring 133 is shown schematically in the figure. In order to release the hearing aid 1 in the ear canal, a releaser 134 is provided at the tool part 2 such that the spring loaded elements 131 may be released from the recesses 132. The release 134 is preferably connected to a cylindrical element 135 which is displaceable in the length direction inside the tool part 2 when the releaser 134 is manually operated from the outside. A guiding magnet (or ferromagnetic element, not shown) could be associated with the tool part and/or the hearing aid part to cause magnetic attraction between the tool and he hearing aid in order to facilitate correct placement of the tool with respect to the hearing aid. This is especially important when the hearing aid is to be extracted from deep within the ear canal, where the user has no visual contact with the tool.

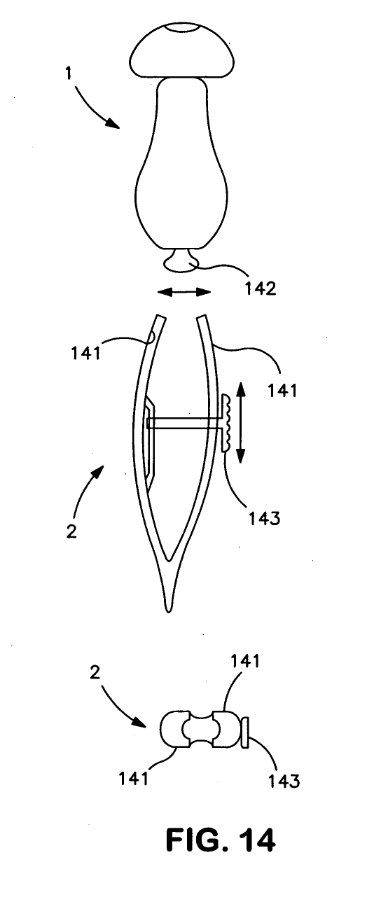

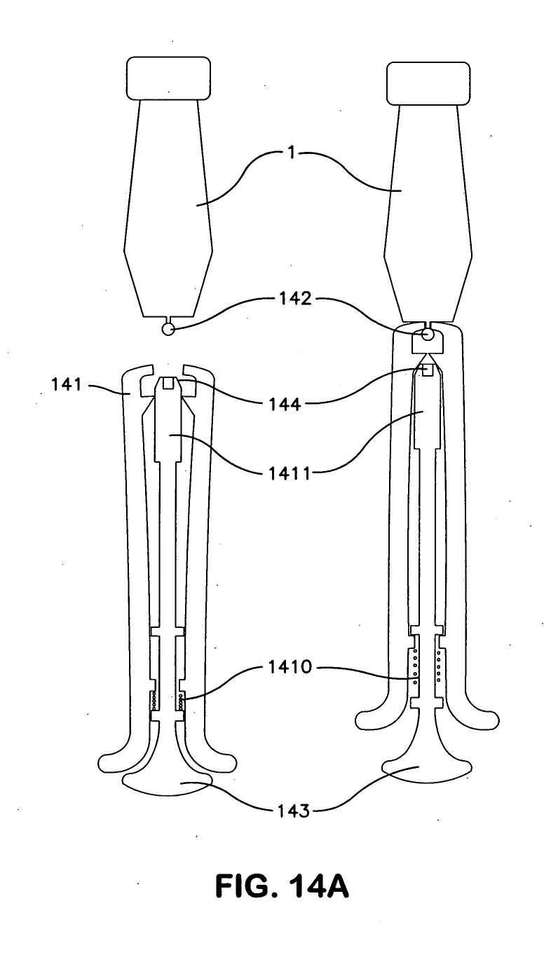

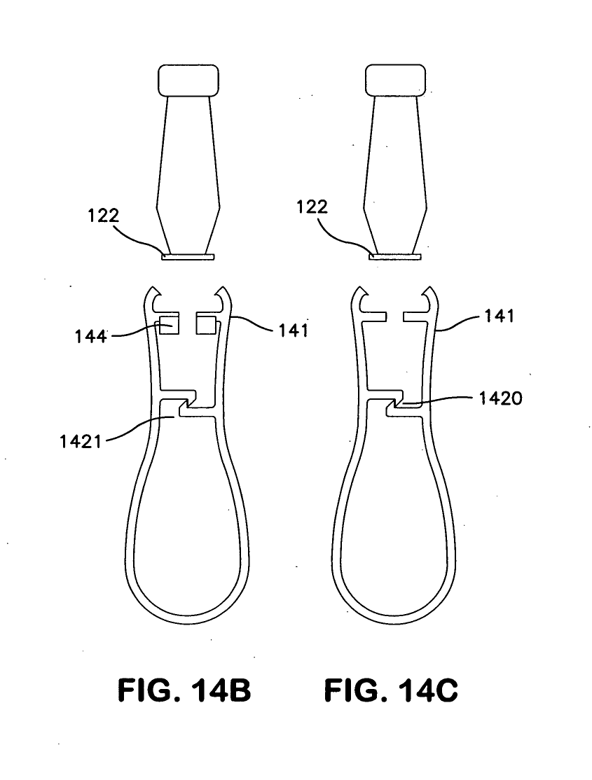

In FIG. 14 a handling tool 2 is shown which comprise a pair of tongs or nippers 141 which, against a spring load, can be actuated to grip a protruding part 142 of the hearing aid 1. The spring load of the tongs are provided in well known manner, by using a material for the tongs which may itself provide this force, however as is also known, a separate spring could also be used, if lesser or more resilient tongs are wished, which could not well provide the gripping force by their own resilience. A locking mechanism or releaser 134 is provided which allows the tongs 141 to maintain a grip on the hearing aid after retraction from the ear. In the shown embodiment the two tongs are provided, however, the skilled person would know that 3, 4 or more tongs could be employed to realize the function. Also, here a guiding magnet associated with either the hearing aid or the tool part may be provided to facilitate the positioning of the tongs inside the ear canal.

A guiding magnet could be provided at either the tool part or the hearing aid connection part to facilitate correct positioning of the tool part at any of the embodiments of the invention even if not specifically mentioned.

An example of the use of a guiding magnet is disclosed in more detail in FIG. 14A. Here the tongs 141 are manoeuvred by a plunger 1411 placed between the tongs 141, and connected to a handle part 143. The tong 141 may be composed of two, three or more individual tong parts shaped as elongate, flexible tongues, which are spread apart by the movement of the plunger 1411. The magnet 144 is associated with the central top part of the plunger 1411 and when the handle 143 is pressed up-wards as shown in the left part of the drawing, the magnet 144 will protrude between the tongue elements, and in this position a strong attraction between the magnet 144 and a protruding magnetisable part 142 of the hearing aid will aid in direction the tip of the tong towards the right position in order to grip the hearing aid. The position where the hearing aid 1 is attached to the tong is shown in the right hand side of the drawing. Here the handle 143 has been retracted by the force of compression spring 1410 and the hearing aid protruding part 142 is firmly seated within the grip of the pair of tongs 141.

Further embodiments of a tool based on a tong principle are disclosed in FIGS. 14B and 14C. No plunger is provided in these embodiments, but as is the case with the embodiment in FIG. 14 the tongs have built in spring action. A magnet 144 is provided in the FIG. 14B embodiment in order to better guide the pair of tongs towards the hearing aid. In both the 14B and 14C embodiment a locking mechanism 1421 and 1420 respectively are schematically indicated such that the tongs may interlock when the hearing aid is firmly gripped, held or released as the case may be.

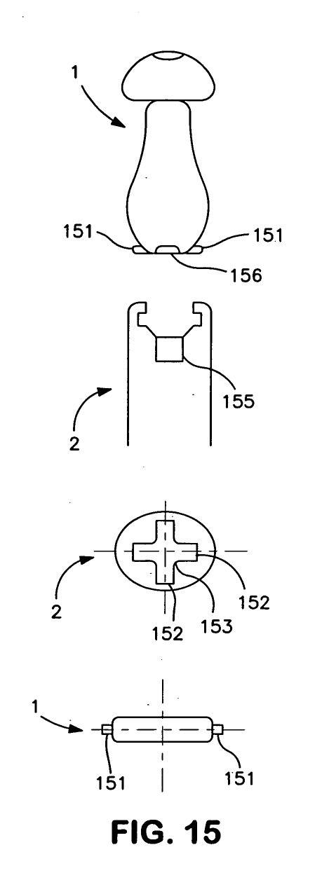

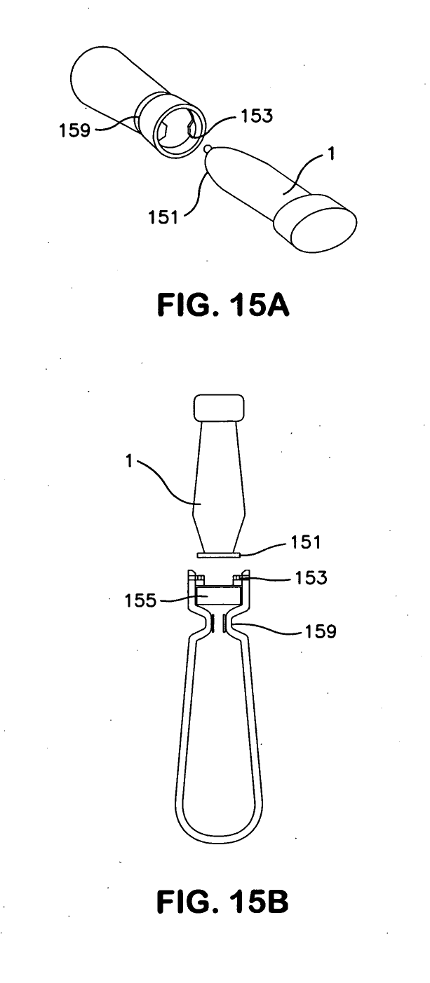

In FIG. 15 a hearing aid and handling tool is shown wherein a bayonet joint is provided between the hearing aid 1 and the handling tool 2. At the rear and of the hearing aid 1 projections 151 are provided which matches recesses 152 at the tool 2. In order to assure connection between tool and hearing aid the tool is moved into abutment with the hearing aid and turned 45 degrees whereby the projections 151 will be gripped behind wall parts 153 of the tool. A magnet 155 is provided at the tool 2 and a corresponding ferromagnetic plate/magnet is provided at the hearing aid 1 to facilitate correct placement of the hearing aid and tool part for interlocking engagement.

In FIGS. 15A and 15B the embodiment of the invention shown in FIG. 15 is shown in two computer-generated shaded drawings, in FIG. 15A a 3D projection is shown with tool and hearing aid apart, but aligned, and in FIG. 15B the same parts are shown in a schematic section. The hearing aid 1 has projections 151 at a rear end thereof, and the tool has opposed projections 153 designed and shaped to form a bayonet lock. When the tool and hearing aid are aligned and the tool is turned the bayonet protrusions 153 on the tool will form a grip behind the protrusions 151 of the hearing aid 1.

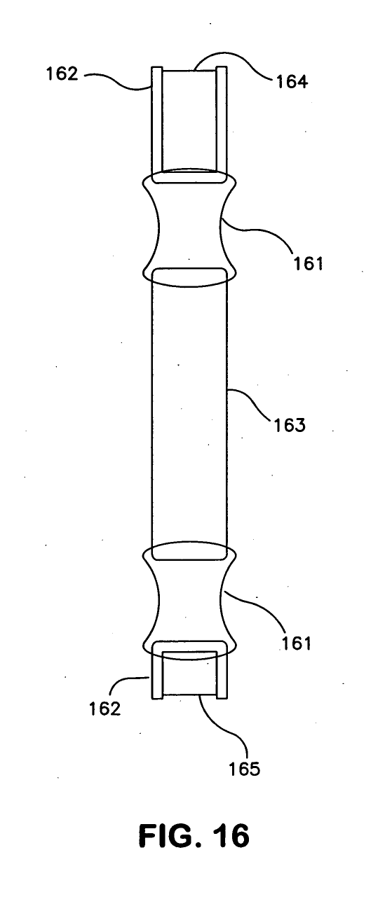

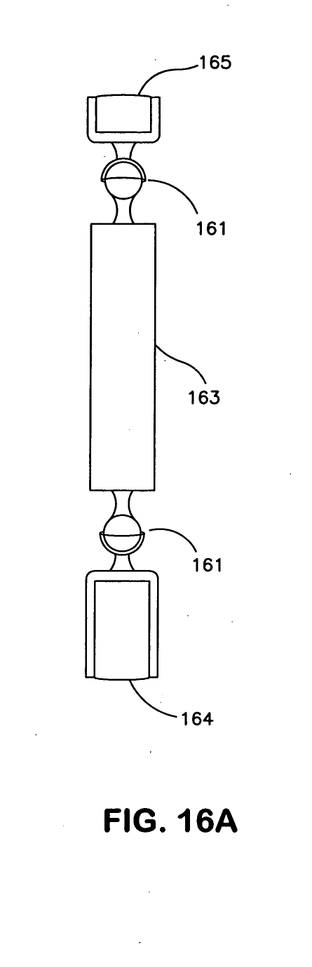

In FIG. 16 a hearing aid and handling tool is shown, wherein a flexible link 161 is provided between the connection means 162 and the tool part is provided. The tool part in FIG. 16 comprises a handle 163. At both ends of the handle a connection means 162 is provided, whereby the connection at the first end comprise a large magnet 164 adapted for pulling out the hearing aid (not shown in FIG. 16) and at the other end comprise a small magnet 165 adapted for insertion of a hearing aid. The smaller magnet 165 provides only a weak attraction which is just sufficient for keeping the hearing aid in place at the tool, and when pushed into the ear canal the hearing aid cannot be re-extracted using this magnet. The sealing or retention element will make sure that there is at least some friction force between the hearing aid and the ear canal which will ensure, that the hearing aid stays in place and cannot be re-extracted with the week magnet. When the hearing aid is to be extracted from the ear canal the tool end with the large magnet 164 is used, and this magnet has a holding force large enough to overcome the friction forces otherwise keeping the hearing aid in place in the ear. In FIG. 16A the flexible link 161 is shaped as a ball joint, whereas the link in FIG. 16 is realized by a flexible material such a flexible polymer.

The flexible link disclosed in connection with the embodiments of FIGS. 16 and 16A may be realized with any of the presented embodiments. A link may be associated in the same manner with the hearing aid between the connection parts and the remaining hearing aid.

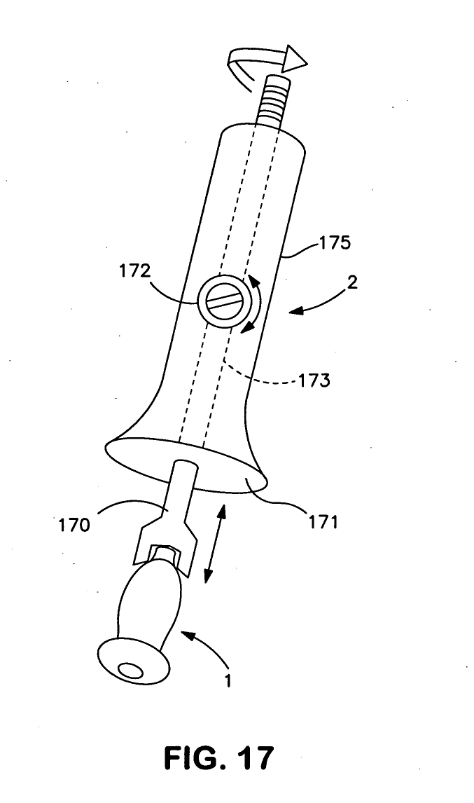

In FIG. 17 the tool 2 comprise an extending element 170 shaped to enter into the ear canal of a hearing aid wearer and stop element 171 proximal to the extending element 170 and shaped to prevent extension thereof into the ear canal. The stop element is provided with a size which prohibits the extension thereof into the ear canal, and in this way it is ensured that the extending element 170 is not inadvertently inserted to deep into an ear canal. By way of a screw 172 a shaft part 173 of the extending element may be secured lengthwise to the handle part 175 of the tool 2, and by way of this arrangement the extension length of the extending part 170 may be adjustable to the individual hearing aid user. A releasable grip between the hearing aid 1 and the extending part is schematically shown, but any kind of releasable grip could be used.

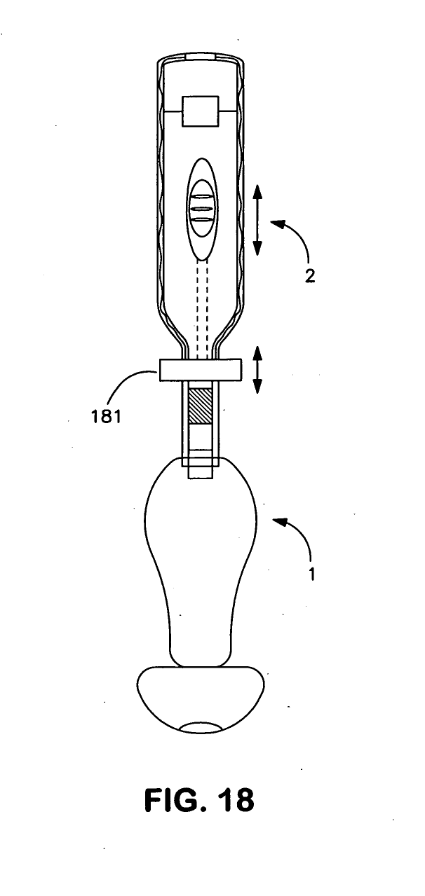

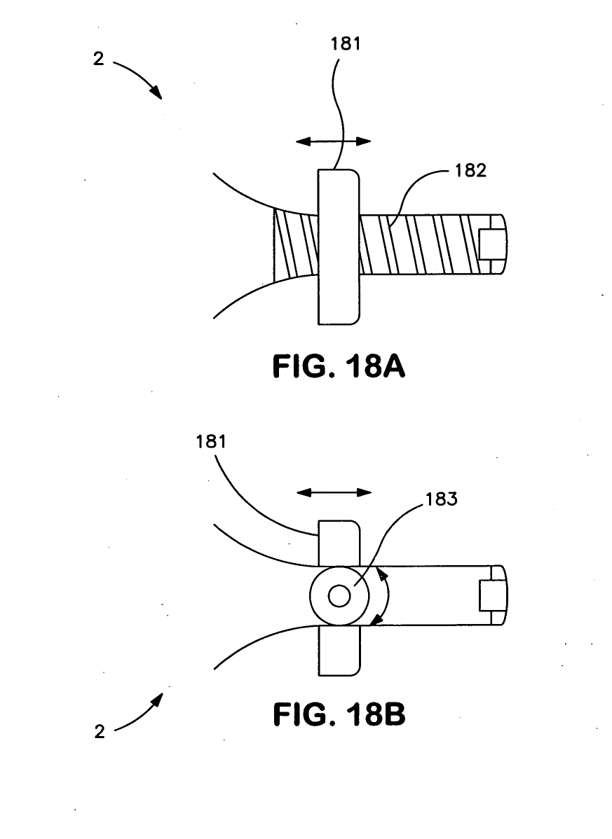

In FIG. 18 a further example of a security measure is disclosed. The tool 2 comprises a tip part which is to enter into the ear, and a mounted slidably onto the tip part, a stop element 181 is provided. The stop element 181 has a size which prohibits the extension thereof into the ear canal. The hearing aid 1 is shown schematically adhered to the tip of the tool 2.

FIG. 18A shows a ratchet mechanism 182 provided at the tool tip part in order to adjust the position of the stop element 181.

In FIG. 18B a further adjustment means is disclosed, and here an adjustment wheel 83 is shown, by way of which the stop element may be moved away from or towards the tip of the tool 2.

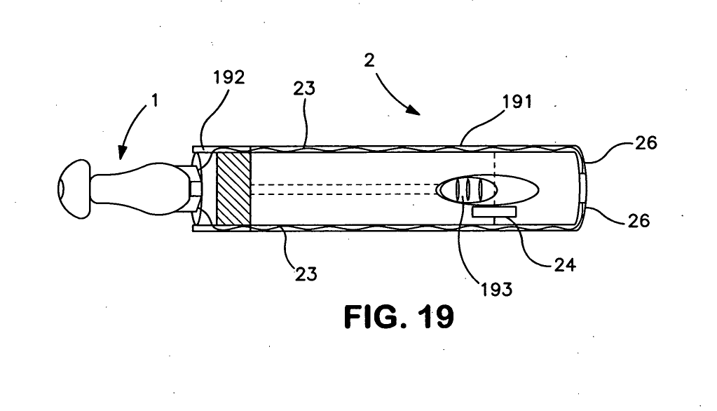

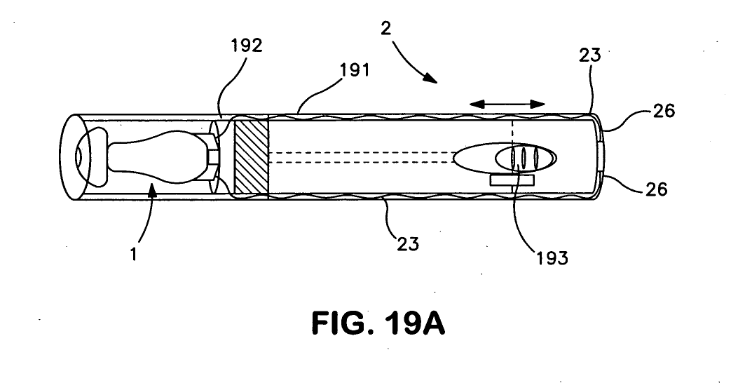

In FIGS. 19 and 19A the handling tool is shown which comprises a cover 191. The attachment part 192 of the tool may be retracted into the cover 191 with the hearing aid 1 attached thereto. This may be realized in a simple manner by a slidable knob 193 being in operational connection with the attachment part 192. In the embodiment shown leads 23 and charging points 26 are schematically shown. The option of a cover which is part of the handling tool may be combined with any of the other described embodiments disclosed in this application.

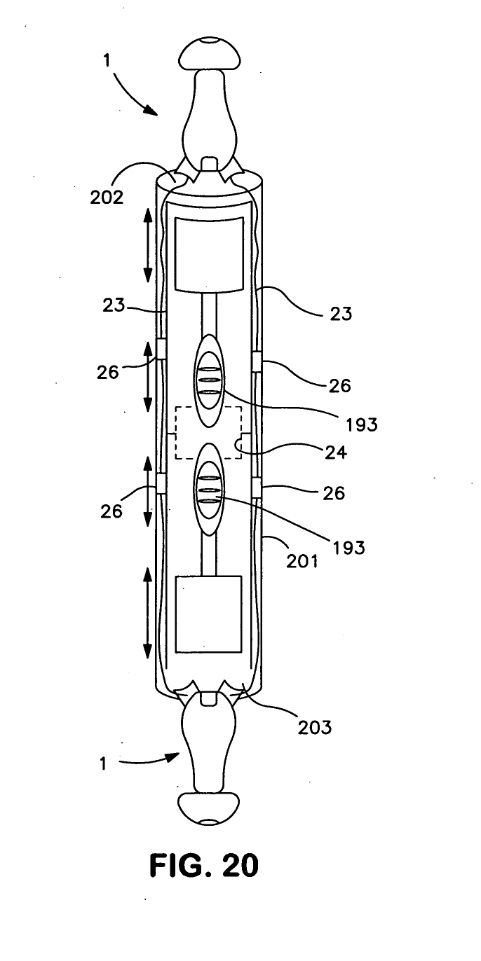

In FIG. 20 an example of the handling tool 2 is disclosed which comprise a handle part and a first connection part 202 extending from the handle part 201 and a second connection part 203 opposed to the first connection part. At both connection parts 202, 203 a hearing aid 1 may be adhered. In this way a hearing aid user has only one tool for handling the hearing aids in both ears. This greatly simplifies the handling of the two hearing aids. Also, in this embodiment charging leads 23 and charging points 26 are schematically shown such that the user may charge the hearing aid batteries by mounting the handle onto a charging unit (not shown). Also, the handling tool may comprise a rechargeable battery 24 of its own as previously mentioned. The option of a handling tool with two hearing aids may be combined with any of the other described embodiment disclosed in this application.

1. A hearing aid and handling tool whereby the hearing aid has all parts thereof inside the ear canal and comprise a casing part with a retention element extending radially between the casing part and the circumference of an ear canal of a user, whereby a sound exit is provided at a first side of the retention element and mechanical connection parts are provided at an opposed side of the retention element wherein complementary mechanical connection parts are provided at the handling tool.

2. A hearing aid and handling tool wherein at least two separate electrical connections are provided at the hearing aid and the handling tool wherein further the two electrical connections at the handling tool gain contact with the respective connections at the hearing aid when the complementary connections at handling tool and the hearing aid are caused to interact.

3. The hearing aid and handling tool as claimed in claim 1, wherein the complementary connection parts of the handling tool or the hearing aid comprise an actuator adapted to generate a magnetic field extending outside a connection part wherein the actuator is switchable between a field generating state and a state where no field is generated.

4. The hearing aid and handling tool as claimed in claim 3, wherein the magnetic actuator comprise either a ferromagnetic part or a permanent magnetic part arranged to move in either translational or rotational fashion to produce the magnetic field outside a surface part of the connection parts of the handling tool.

5. The hearing aid and handling tool as claimed in claim 3, wherein the produced magnetic field is provided by an electromagnetic device.

6. The hearing aid and handling tool as claimed in claim 3, wherein the tool comprise a cylinder adapted for insertion into the ear canal and a magnetic plunger arranged slidable inside the cylinder and a shaft connected to the plunger such that the position of the plunger in the cylinder is controllable by manual operation of the shaft.

7. The hearing aid and handling tool as claimed in claim 3, wherein the tool comprises a first permanent magnet with a first polarization and a second permanent magnet, arranged proximal to the first magnet, whereby the second magnet is mounted in order to slide or rotate with respect to the first magnet, such that the two magnets in a first position of the movable magnet have magnetic fields mutually enforcing each other and in a second position have magnetic fields which cancel each other.

8. The hearing aid and handling tool as claimed in claim 1, wherein interaction of the connection parts of the handling tool and the connection parts of the hearing aid is caused by relative rotation of at least a part of the handling tool with respect to the hearing aid.

9. The hearing aid and handling tool as claimed in claim 8, wherein matching threads are provided on a hearing aid part and a tool part respectively.

10. The hearing aid and handling tool as claimed in claim 8, wherein a bayonet joint is provided between the hearing aid and the handling tool.

11. The hearing and handling tool as claimed in claim 8, wherein the tool tip is shaped with a corkscrew like element and connection parts of the hearing aid comprise loops of wires extending from a surface part thereof.

12. The hearing aid and handling tool as claimed in claim 1, wherein spring loaded locking elements are provided at the handling tool or the hearing aid connection part and mounted for radial movement into and out of engagement with corresponding recesses at the respective opposed part.

13. The hearing aid and handling tool as claimed in claim 12, wherein the spring loaded elements are provided at the handling tool and comprise ball shaped elements which are movable radially inwardly against the spring load by manual operation of a handle placed at the tool.

14. The hearing aid and handling tool as claimed in claim 12, wherein the hearing aid comprise a spring loaded element which are displaceable radially inwardly against the spring load by the motion of the tool in order to lock into radially disposed recesses at the tool part.

15. The hearing aid and handling tool as claimed in claim 12, wherein the handling tool comprise pairs of tongs which, against a spring load, are actuable to grip a protruding part of the hearing aid.

16. The hearing aid and handling tool as claimed in claim 12, wherein a guiding magnet is provided at either the tool part or the hearing aid connection part to facilitate correct positioning of the tool part with respect to the hearing aid connection part.

17. The hearing aid and handling tool as claimed in claim 12, wherein a flexible link is provided between the connection means and the hearing aid or the tool part respectively.

18. The hearing aid and handling tool as claimed in claim 12, wherein the handling tool comprise a handle part and a first connection part extending from the handle part and a second connection part opposed to the first connection part.

19. The hearing aid and handling tool as claimed in claim 12, wherein the tool part comprise an extending element shaped to enter into the ear canal of a hearing aid wearer and stop element proximal to the extending element and shaped to prevent extension thereof into the ear canal.

20. The hearing aid and handling tool as claimed in claim 19, wherein the length of the extending element is adjustable.

21. The hearing aid and handling tool as claimed in claim 12, wherein the handling tool comprises a battery.
